(19) United States
(12) Patent Application Publication
(10) Pub. No.: US 2007/0282807 A1
(43) Pub. Date: Dec. 6, 2007

(54) Systems and methods for contact center analysis

(76) Inventors: John Ringelman, Marietta, GA (US); James Gordon Nies, Carmel, IN (US); Edward Murray, Fairhaven, MA (US); Shimon Keren, Sunnyvale, CA (US)

Correspondence Address: THOMAS, KAYDEN, HORSTEMEYER & RISLEY, LLP, 600 GALLERIA PARKWAY, STE 1500, ATLANTA, GA, 30339, US

(21) Appl. No.: 11/479,267

(22) Filed: Jun. 30, 2006

Related U.S. Application Data
(60) Provisional application No. 60/799,228, filed on May 10, 2006.

(51) Int. Cl. G06F 17/30

(52) U.S. Cl. 707/3

(57) ABSTRACT

Systems and methods for providing integrated solutions for performing workforce management and quality monitoring utilizing an integrated data warehouse system are provided. In this regard, a representative method comprises: generating data from a plurality of workforce optimization (WFO) applications, the WFO applications including, with respect to a workforce, forecasting, scheduling, training, and monitoring fuctionalities; storing the data in a database optimized for extracting the data therefrom; and performing management analytics by querying the database according to at least one usage application, wherein the usage application defines at least one analysis purpose.

### CROSS-REFERENCE TO RELATED APPLICATION

This application claims priority to copending U.S. provisional application entitled, “Systems and Methods for an Integrated Workforce Optimization Database”, having Ser. No. 60/799,228 filed May 10, 2006, which is entirely incorporated herein by reference.

### TECHNICAL FIELD

The present disclosure is generally related to workforce optimization data warehousing, retrieval, and analytics.

### BACKGROUND

The business of a call center, also known as a contact center, is to provide rapid and efficient interaction between agents and customers (or prospective customers). Existing solutions require the purchase of multiple hardware and software components, typically from different vendors, to achieve the business goals of the contact center. The use of separate systems of components leads to a variety of problems. For instance, each system typically has its own method of configuration and its own user interface. Thus, exchanging data between the systems requires additional work by someone at the contact center.

Furthermore, contact centers are continually tasked with striking a balance between service quality, efficiency, effectiveness, revenue generation, cost cutting, and profitability. As a result, today's contact center agents are charged with mastering multiple data sources and systems, delivering consistent service across customer touch points, up-selling, cross-selling, and saving at-risk customers, while winning new ones.

A data warehouse is a collection of computerized data that is organized to optimally support reporting and analysis activity. A data warehouse is subject oriented, thus the data is organized such that all data elements relating to the same real-world event or object are linked together. Also, a data warehouse is time variant, such that changes can be reported over time. Further, a data warehouse is non-volatile such that the data is retained for future reporting. Finally, a data warehouse is integrated, thus containing consistent data from all of an organization's operational applications.

However, compatibility between various systems in an organization can be difficult to obtain in a data warehouse environment. Add multiple sites with distributed products and distributed databases, and the problem increases exponentially. Contact centers often have islands of data that limit analysis ability. While reporting and analysis on individual sites can occur, data warehouse systems have not heretofore addressed consolidated reporting and analysis by tying multiple sites and various products together for a call center.

### SUMMARY

Systems and methods for providing integrated solutions for performing workforce management and quality monitoring utilizing an integrated data warehouse system are provided. In this regard, an exemplary embodiment of such a method comprises: generating data from a plurality of workforce optimization (WFO) applications such as workload forecasting, workload monitoring, employee monitoring, employee scheduling, employee learning, employee quality assessment, and employee performance management, among others, the WFO applications including, with respect to a workforce, forecasting, scheduling, training, and monitoring functionalities; storing the data in a database optimized for extracting the data therefrom; and performing management analytics by querying the database according to at least one usage application, such as analysis, operational reporting, predictive analysis, and/or performance reporting and scorecards, wherein the usage application defines at least one analysis purpose.

An exemplary embodiment of a system for contact center analysis, comprises: a plurality of workforce optimization (WFO) applications configured to generate data related to workforce management, the WFO applications including, with respect to a workforce, forecasting, scheduling, training, and monitoring; a database module, configured to receive the data from the plurality of WFO applications and insert the data into a database optimized for extracting the data therefrom; a plurality of usage applications, each usage application configured to query at least a portion of the data according to an analysis purpose corresponding to the usage application; and at least one usage application, configured for a type of performance reporting, the type of performance reporting including a report containing key performance indicators, the key performance indicators being calculated based on external data and at least a portion of the data from the database.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications and equivalents.

FIG. 1 is a schematic diagram illustrating a contact center environment containing an integrated workforce optimization database.

FIG. 2 is a diagram illustrating one embodiment of an integrated enterprise data warehouse system, utilized in FIG. 1.

FIG. 3 is a diagram illustrating another embodiment of an integrated enterprise data warehouse system, utilized in FIG. 1.

FIG. 4A illustrates an exemplary project management view of an integrated enterprise data warehouse system, utilized in FIG. 1.

FIG. 4B shows exemplary operational processes in a WFO system, as utilized in FIG. 4A.

FIG. 4C illustrates an exemplary data storage component, as utilized in FIG. 4A.

FIG. 4D illustrates exemplary usage applications, as utilized in FIG. 4A.

FIG. 4E illustrates types of analysis, as utilized in FIG. 4D.

FIG. 4F illustrates types of operational reporting, as utilized in FIG. 4D.

FIG. 4G illustrates types of predictive analytics, as utilized in FIG. 4D.

FIG. 4H illustrates types of performance reporting, as utilized in FIG. 4D.

FIG. 5 is a flowchart illustrating an exemplary process for performing contact center analysis utilizing the integrated enterprise data warehouse system in FIG. 1.

### DETAILED DESCRIPTION

Disclosed herein are systems and methods for providing integrated solutions for performing workforce management and quality monitoring utilizing an integrated data warehouse system. Combining these functionalities into a unified integrated database solution, delivered through a single platform, enables users to gain more insight and make smarter decisions faster about sales, service, and overall operations. This takes contact center tools beyond the traditional “suite” approach to a true single workforce optimization platform.

As can be seen, while each technology segment delivers value, integration is the key: together the segments deliver greater impact than the sum of their individual parts. Utilizing them separately limits the contact center's potential to become a strategic business asset.

Workforce related applications collect information and place into a data warehouse or datamart, which consolidates the data and puts it into a structure that makes it more efficient for other applications to perform management analytics.

Exemplary systems are first discussed with reference to the figures. Although these systems are described in detail, they are provided for purposes of illustration only and various modifications are feasible.

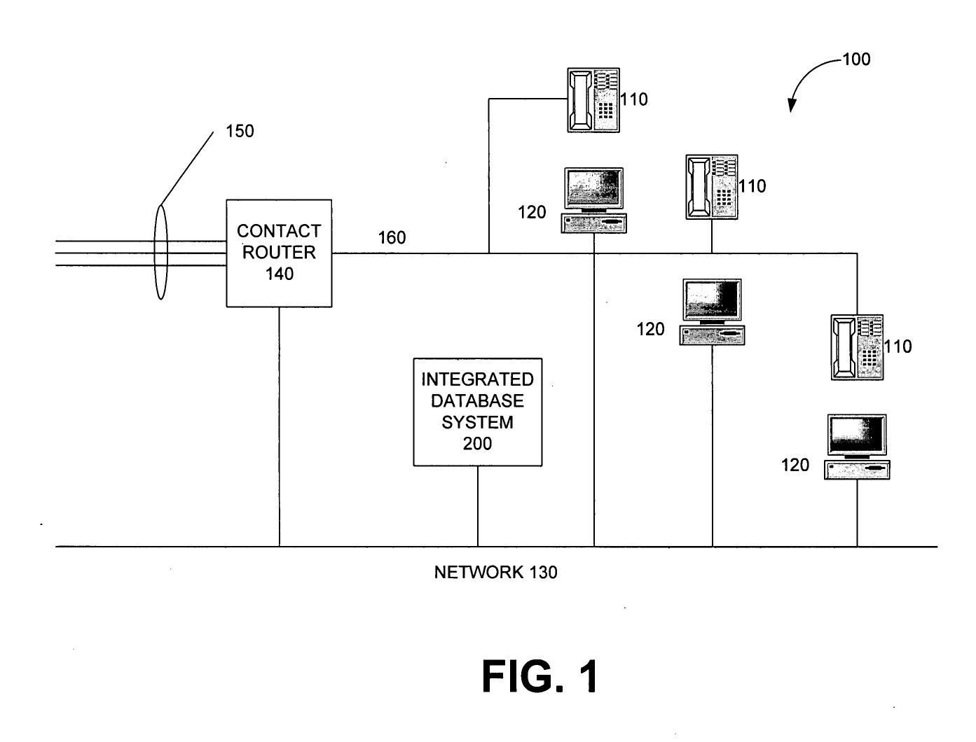

Referring now in more detail to the figures, FIG. 1 illustrates an embodiment a contact center environment 100. The contact center 100 is staffed by agents who handle incoming and/or outgoing contacts. Although the traditional and most common form of contact is by phone, other types of contacts are becoming more common (e.g., text chat, web collaboration, email, and fax). An agent workspace includes an agent phone 110 and a workstation computer 120. A network 130 connects one or more of the workstations 120.

A contact router 140 distributes incoming contacts to available agents. When the contacts are made by traditional phone lines, the contact router 140 operates by connecting outside trunk lines 150 to agent trunk lines 160. In this environment, the contact router 140 may be implemented by an automatic call distributor (ACD), which queues calls until a suitable agent is available. Other types of contacts, such as Voice over Internet Protocol (VoIP) calls and computer-based contacts (e.g., chat, email) are routed over one or more data networks. These contacts are distributed over network 130 to one of the agent workstations 120.

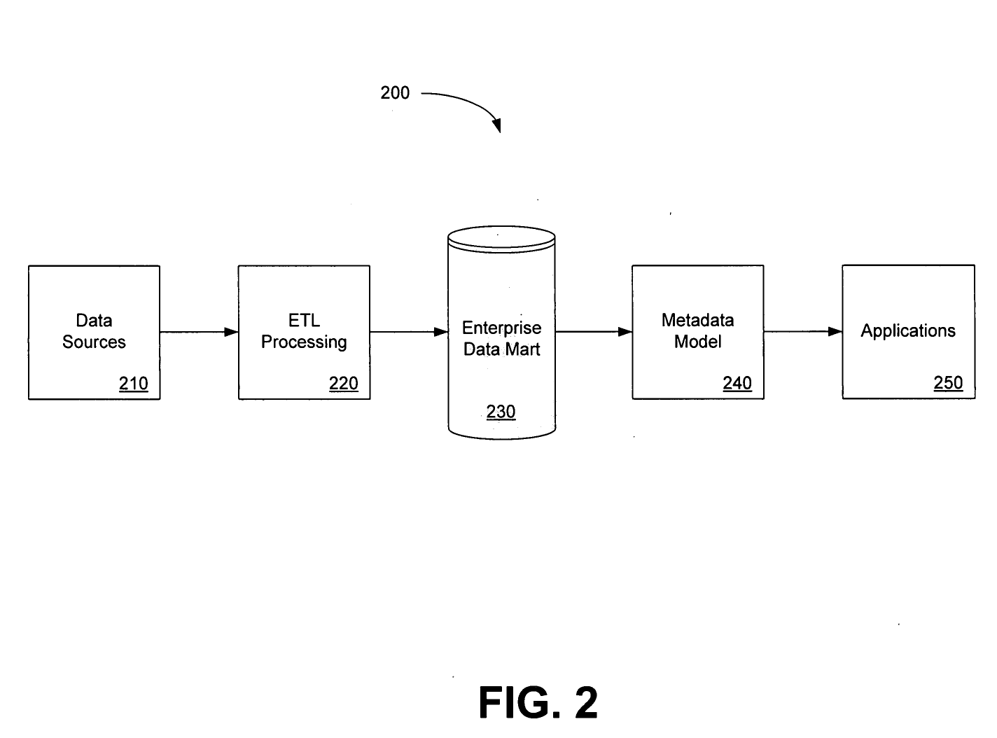

The contact center 100 also includes an integrated workforce optimization database system 200, described in further detail in connection with FIG. 2.

FIG. 2 is a high-level view of components in one embodiment of an integrated enterprise data warehouse system 200. The integrated enterprise data warehouse system 200 includes a data source 210, extract transform and load (ETL) processing 220, an enterprise data mart 230, a metadata model 240 and applications 250. An integrated enterprise data warehouse system such as system 200 allows contact center analysts to quickly access the right information. Such an integrated enterprise data warehouse system 200 allows valuable and previously undiscovered information to be uncovered. This new level of visibility into contact center operations should allow personnel to make better decisions faster.

The integrated enterprise data warehouse system 200 includes multiple workforce related applications, that are brought into a data mart, aggregating information across different products, different sites, and providing applications to give the customer an integrated view of that data across the enterprise and across the products.

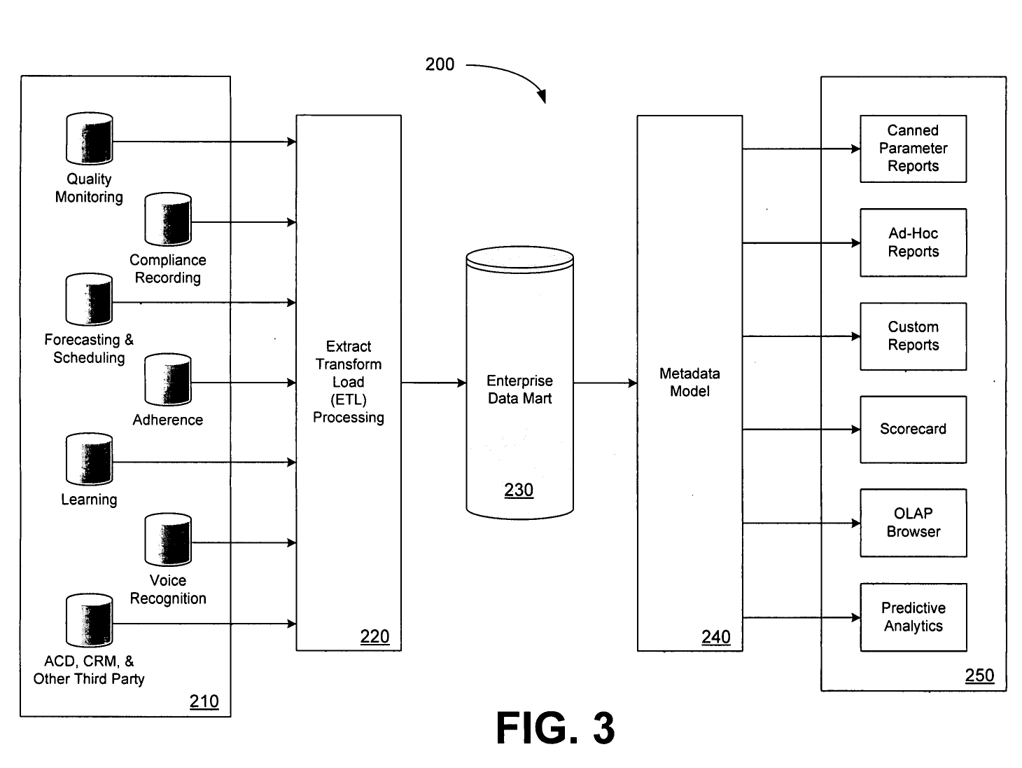

FIG. 3 illustrates an exemplary embodiment of the integrated enterprise data warehouse system 200. A data source 210 is provided by an assortment of different agent workforce related applications. The functionality is typically divided among several agent workforce related applications, executables, processes or services, including quality monitoring, forecasting and scheduling, compliance recording, adherence, learning, voice recognition, ACD, CRM and other third party applications, among others. Typical use of the agent workforce related applications results in data going into one or more databases. ETL processing 220 moves the data, transforms the data, puts the data into a different schema and different format in the enterprise data mart 230. A metadata model 240 provides structure on top of the relational database schema for applications 250 to use. The applications 250 may access the data to provide canned parameter reports, ad-hoc reports, custom reports, scorecards, an OLAP browser, and predictive analytics, among others.

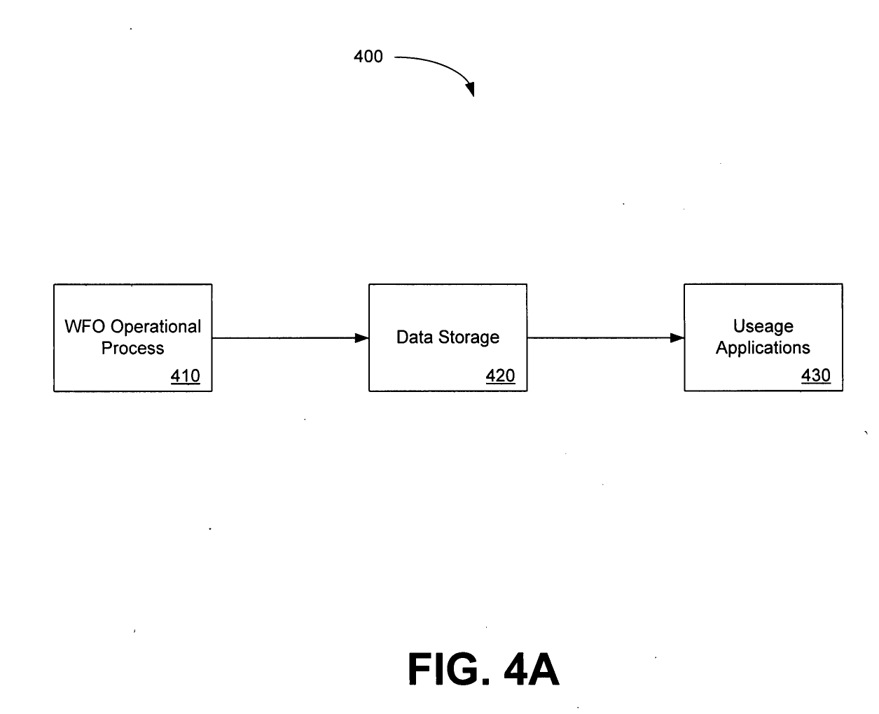

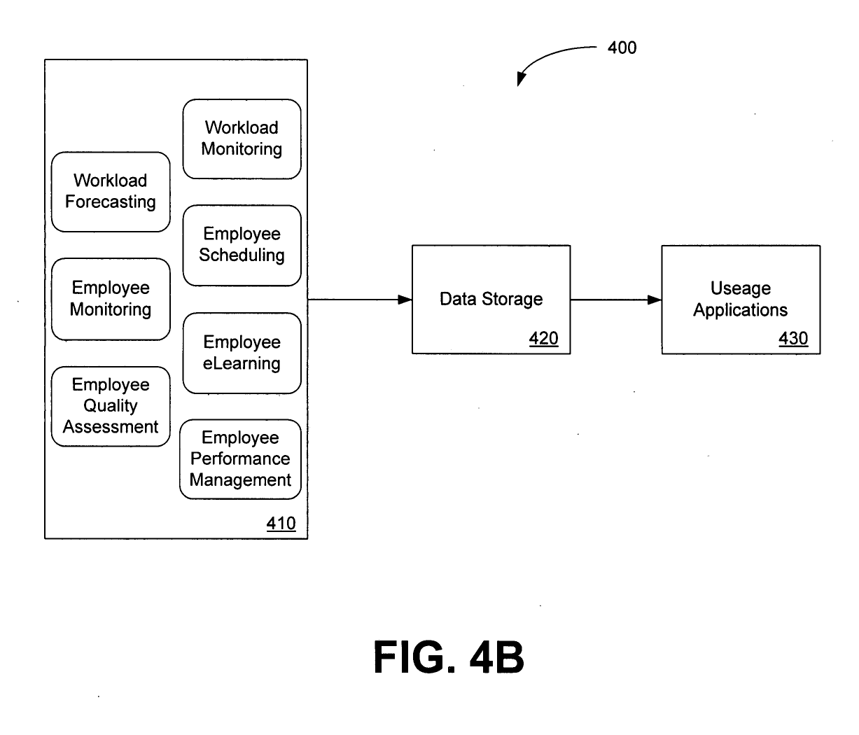

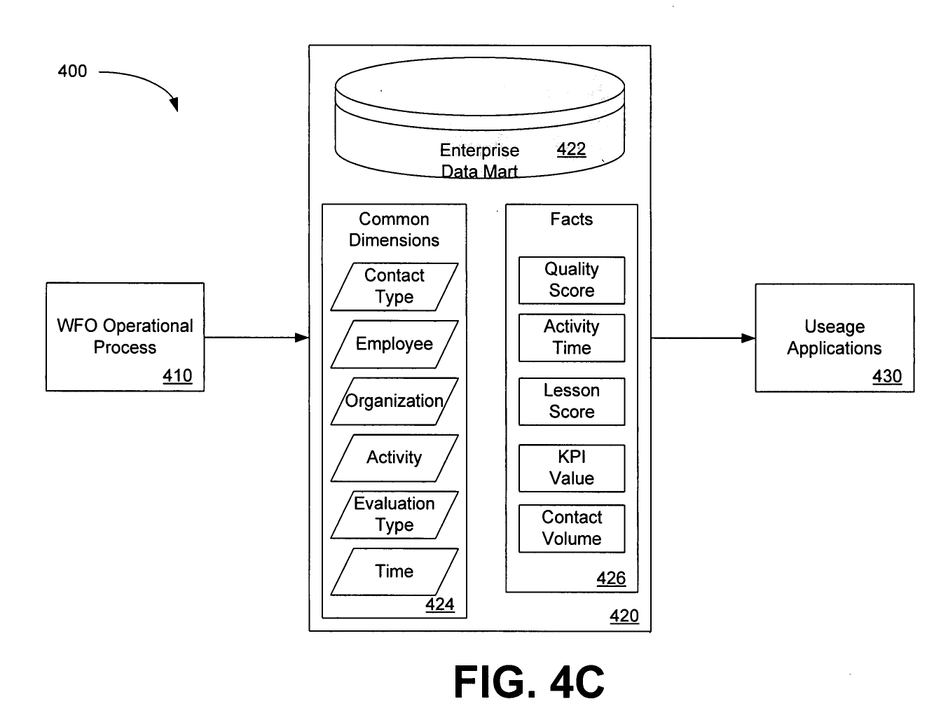

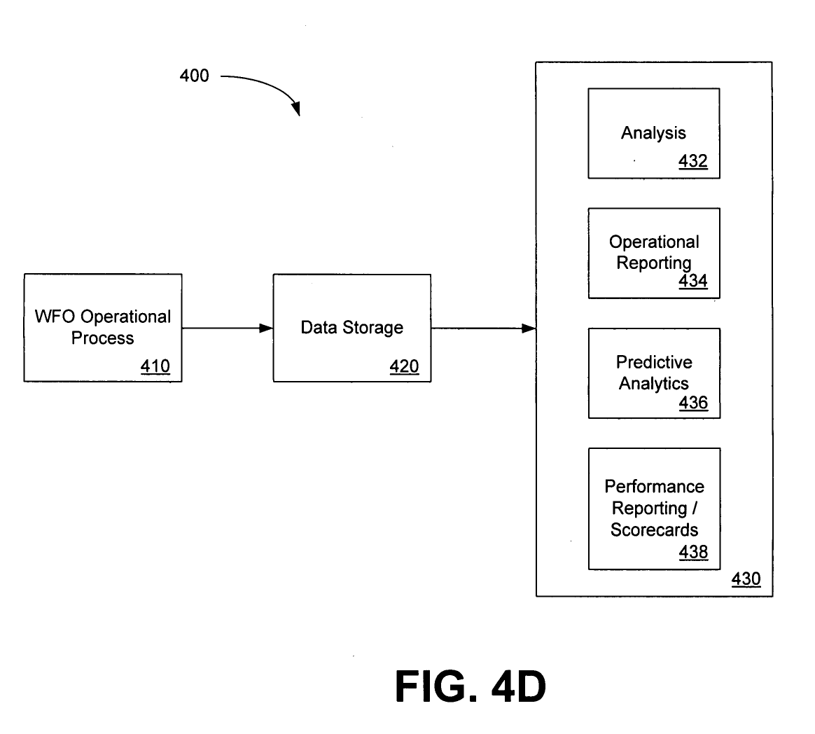

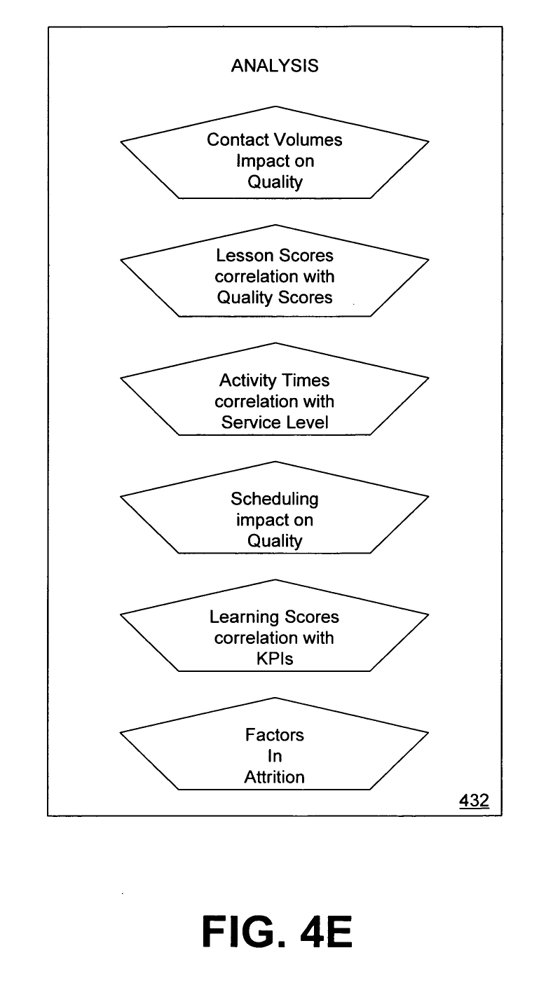

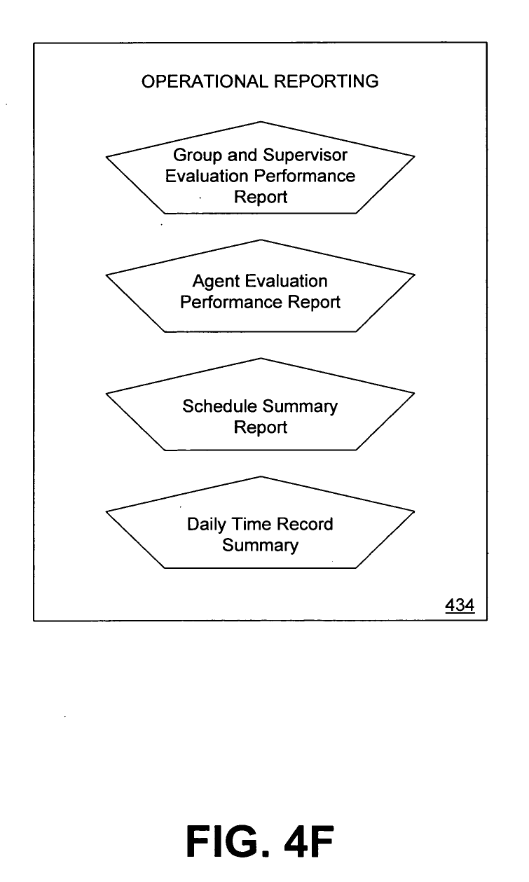

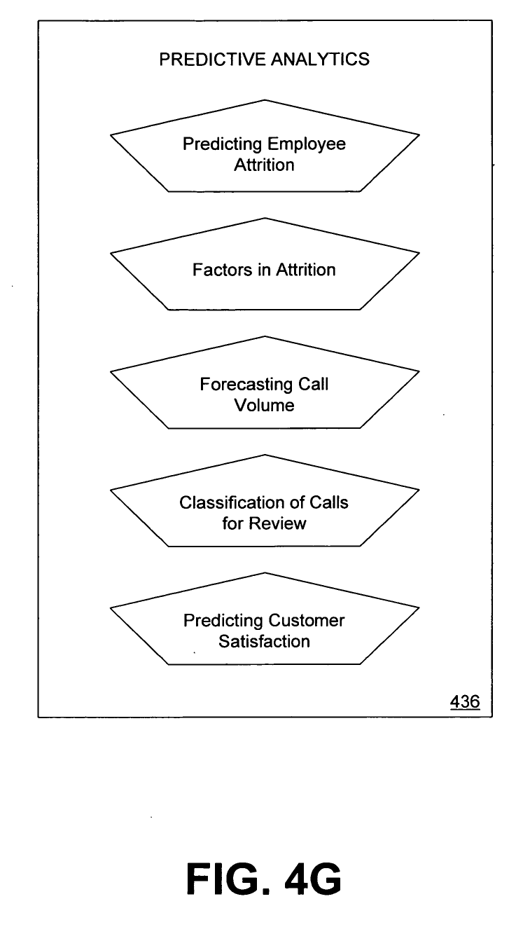

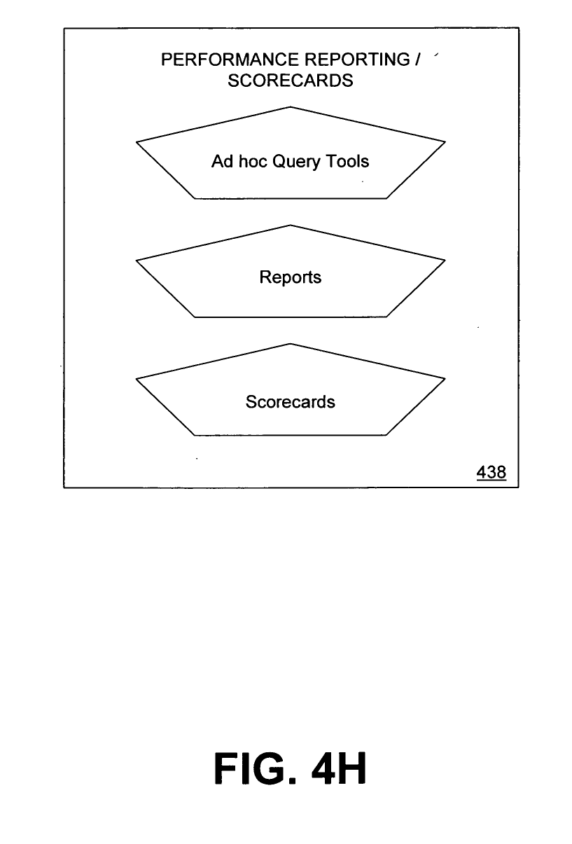

FIG. 4A is a high-level project management view of an integrated enterprise data warehouse system 400. The integrated enterprise data warehouse system 400 includes workforce optimization (WFO) operational processes 410, data storage 420, and usage applications 430.

FIG. 4B shows exemplary operational processes 410 that exist in a WFO system and includes workload forecasting, employee monitoring, employee quality assessment, workload monitoring, employee scheduling, employee learning, and employee performance management, among others. Data is generated from these and other processes and stored in data storeage 420.

FIG. 4C illustrates an exemplary data storage 420 component. Data is stored in an integrated enterprise data mart 422. Some separate data will be generated by the workforce related applications and some common data will be generated. Common data are stored as common dimensions 424 so that comparisons can be made across them. Separate data that can be measured about the operational processes 410 are stored as facts 426.

FIG. 4D shows usage applications 430 illustrating the kinds of analysis that may be performed with the information available. Usage applications 430 allow for analysis 432, operational reporting 434, predictive analytics 436 and performance reporting/scorecards 438. It should be noted that the analysis performed with the usage applications 430 is not limited to merely using the WFO applications. For example, a WFO application might use a quality score when scheduling a contact center agent, while another WFO application might use a call volume corresponding to that same schedule. Both pieces of information are stored in the data mart 422 and available to the usage applications 430. Predictive analytics 436 could then be used to predict customer satisfaction based on a correlation of these and/or other pieces of information.

FIG. 4E illustrates the types of analysis 432. Analysis 432 may include, for example, correlations of the facts 426, such as key performance indicators (KPI), among others, from the data mart 422. A contact volume impact on quality analysis could provide, for example, the impact that contact volume has on a contact center agent's performance. Analysis could also provide a correlation of a contact center agent's lesson scores with any improvement in agent quality scores. Other correlations could include, for example, activity times correlation with service level, scheduling impact on quality, learning scores correlation with KPIs, and factors in attrition, among others.

The analytics is a complex use of the data where a user is able to assess correlations, root causes and opportunities for improvement in their processes. In general, the user will be pulling together data from multiple WFO processes. The multi-process aspect of the data warehouse allows for analysis by organizing the data along a common set of dimensions.

FIG. 4F illustrate the types of operational reporting 434 that may be performed. Operational reporting 434 may include various types of performance reports, such as for example, a group and supervisor evaluation performance report or an agent evaluation performance report. Operational reporting 434 could also include, for example, a schedule summary report, and a daily time record summary, among others.

Operational reports expose data that is fundamental to the WFO process. In one embodiment, a user would typically execute a report based on some combination of parameters specifying attributes such as date range, employees, organization, evaluation forms, among other attributes.

The reports provide a broad spectrum of management information for the needs of users at every level of the contact center, from individual users to contact center managers to system administrators. The reports can be customized for individual users, groups or the contact center. In one embodiment, standard reports can offer a centralized, aggregated view of performance reports or evaluations, for example. In another embodiment, the reports can be on a center-by-center basis for any user within the contact center. In yet another embodiment, amalgamated data from multiple systems can compare common statistics about site activity, such as, for example, “Number of Recorded Calls.”

Operational reporting can be used in one embodiment, for example, to assess evaluation activity, such as changes in performance for an individual agent or group of agents over a period of time. This report, for example, could help to ascertain whether agents are developing their skills appropriately and at an expected pace, for example.

FIG. 4G illustrate the types of predictive analytics 436 that may be performed. Predictive analytics 436 can make use of the facts 426 retrieved from the data mart 422 for many kinds of predictive analysis. An embodiment of predictive analytics 436 may include predicting employee attrition, factors in attrition, forecasting call volume, classification of calls for review, and predicting customer satisfaction, among others.

An embodiment of predictive analytics is an extension of analytics where the user applies statistical models to find correlations and predict that an event is likely to occur in the future based on known factors, for example.

FIG. 4H illustrate the types of performance reporting and scorecards 438 that may be performed. Performance reporting and scorecards 438 may include ad-hoc query tools, reports, and scorecards, among others.

One embodiment of performance reporting and scorecards focuses specifically on key performance indicators (KPI) for people and processes in an organization. Performance reporting and scorecards is similar to operational reporting, in that it is focused on exposing data fundamental to a performance management process. KPIs are calculated in the data warehouse based on data from the WFO applications and from external systems. KPIs are exposed through ad-hoc query tools, reports and the scorecards application, among others.

In one embodiment, Ad-hoc reporting allows analysis across multiple WFO systems by selecting data from more than one WFO application and assembling the data into one report. Data from multiple WFO applications can be mixed and matched to create a user-defined assemblage of data and results.

In another embodiment, Ad-hoc reporting is achieved via a robust query tool, that allows for the creation of graphical and tabular reports based on user requirements. Report queries can be set up in advance and used to create future reports against new data, for example. A broad spectrum of management information is provided to meet the needs of users at every level, from an individual agent to a contact center manager to a systems administrator, among others, and can be customized for individual users, groups, or an entire contact center.

In another embodiment, reports can be saved and then used to view the latest data. A report can also be printed or saved into other formats, such as PDF for example. Reports can be as simple as a list report or as complex as custom charts.

In yet another embodiment, a report can be created from scratch by inserting items from a data source into an empty report. Of course, the data may be provided by one data source or from multiple data sources, such as WFO applications related to forecasting, scheduling, training or monitoring. In an additional embodiment, existing reports may also be used as the basis of a new report, thus a report can be created by opening an existing report, making changes, and then saving the report using another name.

A new report is empty and thus contains no data. In one embodiment, items to be included in the report can be chosen from packages, for example. Exemplary packages include, query subjects, query items such as columns of measures and non-measures, query items created by a data modeler such as calculated report items. Items added from a package to a report are called report items. Report items can appear as columns in list reports, and as rows and columns in cross tab reports. In charts, report items can appear as data markers and axis labels.

In yet another embodiment, the scope of a report can be expanded by inserting additional report items. Of course, the additional report items may be associated with one or more WFO applications. Additionally, the scope of a report can also be narrowed. Focus can be narrowed to specific data by eliminating unnecessary report items.

Query items from different query subjects may be used in the same report. A query subject can be created to contain the desired query items, and then included in a relevant package. Thus, reports can be tailored for specific purposes by an individual user in a mix-and-match fashion.

Saving a report using ad-hoc reporting, results in saving the query definition used to create the report in one embodiment. The query definition is a specific set of instructions for extracting particular data across one or more WFO applications. The report is not a record of the data that was retrieved at the time the report was saved, but rather a report of the current data based on the query definition created when the report was saved. For example, running a report that was saved two weeks ago will generate data that reflects any changes in the updated data source.

In another embodiment, the data corresponding to a given instance can also be saved. A snapshot of given report data can be saved by creating a PDF version of the report.

Another embodiment allows for many types of calculations to be performed utilizing ad-hoc reporting. For example, the sum or average of values in one column can be calculated, or the values in two columns can be multiplied. As noted previously, the source data may derive from one or from multiple WFO applications, for example. The calculation results are not stored unless a snapshot of the report is saved as a PDF version of the report, for example. Rather, ad-hoc reporting reruns any calculations when the report is run. The results will be based on the most current data in the data source.

It should be noted that the usage applications 430 are more than just transactional analysis. While the workforce related applications are utilized for employee scheduling, workload monitoring, quality monitoring, adherence, etc., the usage applications 430 are more about correlations, understanding, ranking, and comparing, for example. The integrated enterprise data warehouse system 400 allows the data from the workforce related applications to be available for other components in an integrated fashion. Facts 426 from different workforce related processes may be analyzed. The analysis could be correlation between facts from different processes, a report an an individual contact center agent such as adherence to schedule, learning scores, etc. The usage applications 430 are able to perform analysis, reports, etc., across combinations of data from multiple workforce related applications. The purpose of the analysis goes beyond mere segmenting of data, to the ways in which the data is queried.

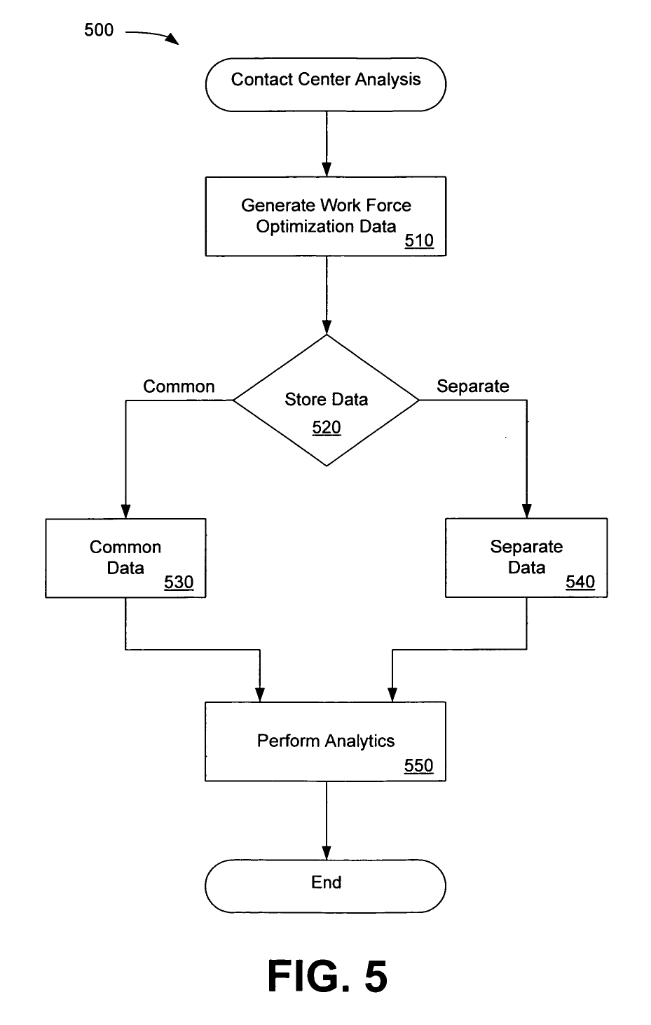

FIG. 5 is a flowchart 500 illustrating an exemplary process for performing contact center analysis utilizing the integrated enterprise data warehouse system 200 shown in FIG. 4A through FIG. 4H. Data is generated by the WFO applications 410 as shown in step 510. Step 520 shows that the data is stored as either common data 530 or separate data 540. Step 550 shows that analytics are performed with both the common data 530 and the separate data 540 available for the usage applications 430.

It should be noted that the flowcharts included herein show the architecture, functionality and/or operation of implementations that may be configured using software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

It should be noted that any of the executable instructions, such as those depicted functionally in the accompanying flowcharts, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, having thus described the disclosure, at least the following is claimed:

1. A method for performing contact center analysis, comprising:
generating data from a plurality of workforce optimization (WFO) applications, the WFO applications including, with respect to a workforce, forecasting, scheduling, training, and monitoring functionalities;
storing the data in a database optimized for extracting the data therefrom; and
performing management analytics by querying the database according to at least one usage application, wherein the usage application defines at least one analysis purpose.

2. The method of claim 1, further comprising storing the data in a database optimized for inserting the data.

3. The method of claim 1, further comprising storing at least a first portion of the data as common data, the common data being common to the plurality of WFO applications, and storing at least a second portion of the data as separate data, wherein the separate data is derived from less than all of the plurality of the WFO applications.

4. The method of claim 3, wherein the performing further comprises comparisons between multiple portions of the common data.

5. The method of claim 3, wherein the performing further comprises utilizing at least a portion of the separate data for obtaining facts specific to at least one of the WFO applications.

6. The method of claim 1, wherein the usage application specifies a type of analysis, the type of analysis including a correlation between multiple portions of the data from the database, wherein the data is related to multiple WFO applications.

7. The method of claim 1, wherein the usage application specifies a type of operational reporting, the type of operational reporting including a report containing at least a portion of the data from the database, wherein the data is related to multiple WFO applications.

8. The method of claim 1, wherein the usage application specifies a type of predictive analytics, the type of predictive analytics including predictions utilizing statistical models and being based at least in part on the data from the database, wherein the data is related to multiple WFO applications.

9. The method of claim 1, wherein the usage application specifies a type of performance reporting, the type of performance reporting including a report containing key performance indicators, the key performance indicators being calculated based on external data and at least a portion of the data from the database, wherein the data is related to multiple WFO applications.

10. A system for contact center analysis, comprising:
a plurality of workforce optimization (WFO) applications configured to generate data related to workforce management, the WFO applications including, with respect to a workforce, forecasting, scheduling, training, and monitoring;
a database module, configured to receive the data from the plurality of WFO applications and insert the data into a database optimized for extracting the data therefrom;
a plurality of usage applications, each usage application configured to query at least a portion of the data according to an analysis purpose corresponding to the usage application; and
at least one usage application, configured for a type of performance reporting, the type of performance reporting including a report containing key performance indicators, the key performance indicators being calculated based on external data and at least a portion of the data from the database.

11. The system of claim 10, further comprising means to insert at least a portion of the data as common data, the common data being common to the plurality of WFO applications, and further configured to insert at least a second portion of the data as separate data, the separate data derived from less than all of the plurality of the WFO applications.

12. The system of claim 10, further comprising means for comparison of multiple portions of the common data.

13. The system of claim 10, further comprising means for utilizing at least a portion of the separate data to determine correlations between multiple WFO applications.

14. The system of claim 10, wherein at least one usage application is configured for a type of analysis, the type of analysis including a correlation between multiple portions of the data from the database.

15. The system of claim 10, wherein at least one usage application is configured for a type of operational reporting, the type of operational reporting including a report containing at least a portion of the data from database.

16. The system of claim 10, wherein at least one usage application is configured for a type of predictive analysis, the type of predictive analytics including predictions utilizing statistical models and being based at least in part on the data from the database.

17. The system of claim 10, further comprising a display device operative to display an output of at least one of the usage applications.

18. The system of claim 10, further comprising means for displaying an output of at least one of the usage applications.

19. A computer readable medium having a computer program stored thereon, the computer program comprising computer-executable instructions for performing the computer-implemented steps of:
generating data from a plurality of workforce optimization (WFO) applications, the WFO applications including, with respect to a workforce, forecasting, scheduling, training, and monitoring functionalities;
storing the data in a database optimized for extracting the data therefrom;
storing at least a first portion of the data as common data, the common data being common to the plurality of WFO applications;
storing at least a second portion of the data as separate data, wherein the separate data is derived from less than all of the plurality of the WFO applications; and
performing management analytics by querying the database according to at least one usage application, the usage application defining at least one analysis purpose.
